(19) United States
(12) Patent Application Publication
(10) Pub. No.: US 2025/0343293 A1
(43) Pub. Date: Nov. 6, 2025

(54) PORTABLE COUNTER-CURRENT FLOW THERMAL MANAGEMENT SYSTEM FACILITATING COOLING OF BATTERY PACK, AND METHOD THEREOF

(71) Applicants: Prem Dilipbhai Bhojwani, Bhurawaw, Godhra (IN); Gitaben Dilipkumar Bhojwani, Bhurawaw, Godhra (IN)

(72) Inventors: Prem Dilipbhai Bhojwani, Bhurawaw, Godhra (IN); Gitaben Dilipkumar Bhojwani, Bhurawaw, Godhra (IN)

(21) Appl. No.: 19/196,020

(22) Filed: May 1, 2025

(30) Foreign Application Priority Data
May 2, 2024 (IN) 202421035019

(51) Int. Cl. H01M 10/6552; H01M 10/613; H01M 10/63; H01M 10/653; H01M 10/6551; H01M 50/30

(52) U.S. Cl. CPC H01M 10/6552; H01M 10/613; H01M 10/63; H01M 10/653; H01M 10/6551; H01M 50/30

(57) ABSTRACT

The present invention discloses a portable counter-current flow thermal management system facilitating cooling of a battery pack. System comprises at least one pump, first and second connecting tubes, and heat exchanger unit. The at least one pump enables circulation of a cooling agent with pre-defined rate of flow based on real-time temperature data detected from the battery pack. The cooling agent may include a liquid, a gas, a dielectric fluid, and glycol compound. First connecting tube facilitates flow of cooling agent. Heat exchanger receives and automatically adjusts the temperature of the cooling agent. The second connecting tube receives cooling agent and provides to input terminal is coupled to output terminal along a horizontal axis in a bent fashion facilitating a single interface enabling counter-current flow of cooling agent across battery cells in battery pack.

### TECHNICAL FIELD

The present disclosure relates generally to the field of battery energy storage systems. In particular, the present disclosure relates to a portable counter-current flow thermal management system facilitating cooling of a battery pack, and method thereof.

### BACKGROUND

Background description includes information that may be useful in understanding the present invention. It is not an admission that any of the information provided herein is prior art or relevant to the presently claimed invention, or that any publication specifically or implicitly referenced is prior art.

In energy storage systems advanced technology battery cells are used to have certain limitations in power, energy, and life cycle. For various applications battery cells have to connect in series and/or parallel, and for high power and energy application, the cells require a thermal stability system as these advanced technology battery cells has certain limitation of operating temperature. The battery cells can best perform in operating temperature of 25 degrees Celsius. Globally, there is wide range of temperature variations from −70 degree Celsius to +70 degree Celsius. Due to global warming, the temperature is increasing rapidly resulting in a major difference in temperature across the world. During high power and/or energy applications the battery cells generate high heat and are trapped inside the battery pack due to an air gap, which results in thermal failure and/or fire explosion. The maximum surface of the battery cell is surrounded by a highly thermal conductive hybrid composite material and covered with portable cooling tubes/pipes for the active cooling.

Currently, the cooling system that is being used in battery pack has one inlet in one side and an outlet in another side. The temperature at the inlet side of battery cells is maintained, but the temperature at the outlet side of battery cells is not controlled as required due the exchange of heat of the other cells in its path. It is quite complicated and difficult to maintain the temperature as well the manufacturability. Conventional battery cells have a limited cycle life and so a fixed thermal management system cannot be used due to its portability and/or flexibility thereby leading to the generation of high debris and waste.

One of the existing applications discloses a motor vehicle battery including a battery housing. The battery housing has a housing interior bounded in sections by a housing frame and a housing base. The motor vehicle battery further includes a plurality of battery modules arranged in the housing interior. The motor vehicle battery further includes at least one first cooling duct. The at least one first cooling duct is formed in the region of the housing base, for cooling the battery modules from a first side. The housing interior is bounded by a housing cover or by a housing lid opposite the housing base. At least one second cooling duct for cooling the battery modules from a second side is formed in the region of the housing cover or of the housing lid.

Another existing application discloses a counterflow heat exchanger for battery thermal management has a base plate, a cover plate and manifold cover. The base plate includes alternating first and second longitudinal fluid flow passages. The cover plate is sealed to the base plate to enclose the first and second fluid flow passages and includes a first fluid opening and a plurality of second fluid openings arranged at spaced apart intervals across a width of the cover plate. The manifold cover includes an embossment surrounded by a peripheral flange which is sealed to the cover plate and surrounds at least the plurality of second fluid openings. The interior of the embossment defines a manifold chamber in flow communication with the second fluid openings in the cover plate. The top of the manifold cover has at least a second fluid opening in flow communication with the plurality of second fluid openings through the manifold chamber. However, none of the existing applications provide an efficient solution to the said problem.

There is, therefore, a need to overcome the above-mentioned drawbacks, shortcomings, and limitations associated with the existing solutions that enable thermal management in battery pack.

### OBJECTS OF THE PRESENT DISCLOSURE

Some of the objects of the present disclosure, which at least one embodiment herein satisfy are as listed herein below.

It is an object of the present disclosure to overcome the above drawbacks, shortcomings, and limitations associated with existing solutions that implement a portable counter-current flow thermal management system facilitating cooling of a battery pack, and method thereof.

It is an object of the present disclosure is to provide a system and method enabling a simple, a reusable, a reliable and a portable counter-current flow thermal management system to maintain temperature of a battery pack.

It is an object of the present disclosure is to provide a system which eliminates presence of air gap in the battery pack. The maximum surface of the battery cell is surrounded by a highly thermal conductive hybrid composite material.

It is an object of the present disclosure is to enable implementation of a simple and effective countercurrent flow of a coolant agent which can be circulating to/from the battery cells in a parallel mode based on a temperature difference of the battery cells.

It is an object of the present disclosure to provide a flexible, a reusable, an efficient battery cell to battery pack by reducing the complexity, manpower, import dependency, generation of debris, with high manufacturing portability without compromising the external weather applications.

It is an object of the present disclosure provides a scalable, a cost-effective and easy on-site maintenance portable counter-current flow thermal management system.

### SUMMARY

The present disclosure relates generally to the field of battery energy storage systems. In particular, the present disclosure relates to a portable counter-current flow thermal management system facilitating cooling of a battery pack, and method thereof.

An aspect of the present disclosure pertains to a portable counter-current flow thermal management system facilitating cooling of a battery pack. The system comprises at least one pump, a first connecting tube, a heat exchanger unit, and a second connecting tube. The at least one pump can be configured enable circulation of a cooling agent with a pre-defined rate of flow based on a real-time temperature data detected from the battery pack. The first connecting tube can be operatively coupled to the at least one pump and can be configured to facilitate flow of the cooling agent. The heat exchanger unit can be operatively coupled to the first connecting tube (104), and configured to receive the cooling agent, and automatically adjust the temperature of the cooling agent. The second connecting tube can be operatively coupled to the heat exchanger unit and configured to receive and provide a counter-current flow of the cooling agent to one or more battery cells in the battery pack. Further, the second connecting tube comprises an input terminal and an output terminal. An input terminal can be configured to receive and conduct charging of the cooling agent to facilitate the thermal management by circulating the cooling agent with a pre-defined temperature range to the one or more battery cells. The output terminal can be configured to conduct discharging of the cooling agent to facilitate the thermal management by circulating the cooling agent with the pre-defined temperature range from the one or more battery cells.

In an aspect, the output terminal can be coupled to the input terminal along a horizontal axis in a bent fashion facilitating a single interface enabling the counter-current flow of the cooling agent across one or more battery cells in the battery pack.

In an aspect, the counter-current flow of the cooling agent is based on a fish gill-based technique for providing thermal management and facilitating cooling of the one or more battery cells in the battery pack.

In an aspect, the fish gill-based technique is configured to enable flow of a charged cooling agent and a discharged cooling agent through the second connecting tube and the one or more battery cells in a parallel mode.

In an aspect, the system can be configured to enable the counter-current flow of the cooling agent based on the fish gill based technique though a first end of the second connecting tube comprising at least one of the input terminal and the output terminal, and a second end of the second connecting tube being end cover.

In an aspect, the charged cooling agent pertains to directing the flow of the cooling agent with a low temperature range from the input terminal to the one or more battery cells. The discharged cooling agent pertains to directing flow of the cooling agent with a high temperature range from the one or more battery cells to the output terminal and the at least one pump.

In an aspect, the second connecting tube can comprise one or more vortex units which are configured to enable circular flow of the cooling agent along with one or more partitions. The one or more vortex units can be configured to allow the cooling agent to change the circulating flow area based on a pre-defined length of the second connecting tube and the pre-defined temperature range.

In an aspect, the one or more vortex units can be configured to enable the flow of the cooling agent through a countercurrent based channel with the one or more partitions, which allows transfer of the charged cooling agent and the discharged cooling agent at respective area.

In an aspect, the one or more partitions can be configured to maintain the pre-defined temperature of the cooling agent. A count of one or more partitions depends on the pre-defined length of the second connecting tube.

In an aspect, the cooling agent comprises at least one of a liquid, a gas, a dielectric fluid, and a glycol compound.

In an aspect, the system comprises a coating material comprising a highly thermal conductive hybrid composite material covering a maximum surface of the one or more battery cells. The coating material can comprise at least one of a Carbon Nanotube (CNT) composite, a Boron Nitride Nanotube (BNNT) composite, and a Graphene-based composite with at least one of a low atmosphere pressure, and/or a high atmosphere pressure, and/or a vacuum based on an application requirement, to maintain the temperature of at least one of the battery pack and a system associated in at least one of a water, an air, a space and/or a underwater, with a requirement of cooling.

In an aspect, the system comprises at least one pressure vent configured to release the pressure from inside of the battery pack due to one or more chemical reactions of the one or more battery cells during operation.

In an aspect, the charged cooling agent is configured to reduce the temperature of the one or more battery cells.

In an aspect, the system comprises one or more terminal signal pins configured to monitor one or more parameters of the one or more battery cell. The one or more parameters comprise at least one of a capacity of the battery cell, an energy density, a self-discharge rate, and an operating temperature of the battery cell.

In an aspect, one or more electrical external connections of the battery pack interconnected to at least one battery cell terminals, and the one or more battery cells.

In an aspect of the present disclosure discloses a method for facilitating cooling of a battery pack by using a portable counter-current flow thermal management system. The method comprises the step of enabling, by a pump, circulation of a cooling agent with a pre-defined rate of flow based on a real-time temperature data detected from the battery pack. The cooling agent comprises at least one of a liquid, a gas, a dielectric fluid, and a glycol compound. The method comprises the step of receiving, by heat exchanger unit, the cooling agent and automatically adjusting a pre-defined temperature of the cooling agent. The method comprises the step of providing, by a second connecting tube, a counter-current flow of the cooling agent to one or more battery cells in the battery pack. The second connecting tube comprising the step of receiving and conducting, by an input terminal, charging of the cooling agent to facilitate the thermal management by circulating the cooling agent with a pre-defined temperature range to the one or more battery cells. The second connecting tube comprising the step of conducting, by an output terminal, discharging of the cooling agent to facilitate the thermal management by circulating the cooling agent with the pre-defined temperature range from the one or more battery cells. The output terminal can be coupled to the input terminal along a horizontal axis in a bent fashion facilitating a single interface enabling the counter-current flow of the cooling agent across one or more battery cells in the battery pack.

In an aspect, the counter-current flow of the cooling agent is based on a fish gill-based technique for providing thermal management and facilitating cooling of the one or more battery cells in the battery pack.

In an aspect, the method comprises the step of enabling, by a portable counter-current flow thermal management system, flow of a charged cooling agent and a discharged cooling agent through the second connecting tube and the one or more battery cells in a parallel mode.

In an aspect, the method comprises the step of enabling, by a portable counter-current flow thermal management system, the counter-current flow of the cooling agent based on the fish gill based technique though a first end of the second connecting tube comprising at least one of the input terminal and the output terminal, and a second end of the second connecting tube being end cover.

Various objects, features, aspects, and advantages of the present disclosure will become more apparent from the following detailed description of preferred embodiments, along with the accompanying drawing figures in which like numerals represent like features.

Within the scope of this application, it is expressly envisaged that the various aspects, embodiments, examples, and alternatives set out in the preceding paragraphs, in the claims and/or in the following description and drawings, and in particular the individual features thereof, may be taken independently or in any combination. Features described in connection with one embodiment are applicable to all embodiments unless such features are incompatible.

### BRIEF DESCRIPTION OF DRAWINGS

The accompanying drawings are included to provide a further understanding of the present invention and are incorporated in and constitute a part of this specification. The drawings illustrate exemplary embodiments of the present invention and, together with the description.

FIG. 1 illustrates an exemplary architecture of the proposed portable counter-current flow thermal management system, in accordance with an embodiment of the present disclosure.

FIG. 2 illustrates an exemplary representation of a countercurrent flow of a cooling agent in the proposed system, in accordance with an embodiment of the present disclosure.

FIGS. 3A-3B illustrates an exemplary architecture of an exploded isometric view and a battery pack isometric view without top cover, respectively, in accordance with an embodiment of the present disclosure.

FIGS. 4A-4B illustrates an exemplary architecture of a front view cross-section from cell with countercurrent flow liquid cooling tubes, and a battery pack exploded side view, respectively, in accordance with an embodiment of the present disclosure.

FIGS. 5A-5F illustrates an exemplary architecture representing different views of connecting tubes with countercurrent flow of the cooling agent, in accordance with an embodiment of the present disclosure.

FIGS. 6A-6C illustrates an exemplary architecture representing different views of cooling channels with countercurrent flow of the cooling agent in the connecting tubes, in accordance with an embodiment of the present disclosure.

FIGS. 7A-7C illustrates an exemplary representation of a countercurrent flow of a cooling agent in the proposed system, in accordance with an embodiment of the present disclosure.

FIGS. 8A-8C illustrates an exemplary architecture of a portable counter-current flow thermal management system in rectangular form, in accordance with an embodiment of the present disclosure.

FIG. 9 illustrates an exemplary flow diagram depicting a method for facilitating cooling of a battery pack by using a portable counter-current flow thermal management system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

The present disclosure relates generally to the field of battery energy storage systems. In particular, the present disclosure relates to a portable counter-current flow thermal management system facilitating cooling of a battery pack, and method thereof.

An aspect of the present disclosure pertains to a portable counter-current flow thermal management system facilitating cooling of a battery pack. The system comprises at least one pump, a first connecting tube, a heat exchanger unit, and a second connecting tube. The at least one pump can be configured enable circulation of a cooling agent with a pre-defined rate of flow based on a real-time temperature data detected from the battery pack. The first connecting tube can be operatively coupled to the at least one pump and can be configured to facilitate flow of the cooling agent. The heat exchanger unit can be operatively coupled to the first connecting tube (104), and configured to receive the cooling agent, and automatically adjust the temperature of the cooling agent. The second connecting tube can be operatively coupled to the heat exchanger unit and configured to receive and provide a counter-current flow of the cooling agent to one or more battery cells in the battery pack. Further, the second connecting tube comprises an input terminal and an output terminal. An input terminal can be configured to receive and conduct charging of the cooling agent to facilitate the thermal management by circulating the cooling agent with a pre-defined temperature range to the one or more battery cells. The output terminal can be configured to conduct discharging of the cooling agent to facilitate the thermal management by circulating the cooling agent with the pre-defined temperature range from the one or more battery cells.

In an aspect, the output terminal can be coupled to the input terminal along a horizontal axis in a bent fashion facilitating a single interface enabling the counter-current flow of the cooling agent across one or more battery cells in the battery pack.

In an aspect, the counter-current flow of the cooling agent is based on a fish gill-based technique for providing thermal management and facilitating cooling of the one or more battery cells in the battery pack.

In an aspect, the fish gill-based technique is configured to enable flow of a charged cooling agent and a discharged cooling agent through the second connecting tube and the one or more battery cells in a parallel mode.

In an aspect, the system can be configured to enable the counter-current flow of the cooling agent based on the fish gill based technique though a first end of the second connecting tube comprising at least one of the input terminal and the output terminal, and a second end of the second connecting tube being end cover.

In an aspect, the charged cooling agent pertains to directing the flow of the cooling agent with a low temperature range from the input terminal to the one or more battery cells. The discharged cooling agent pertains to directing flow of the cooling agent with a high temperature range from the one or more battery cells to the output terminal and the at least one pump.

In an aspect, the second connecting tube can comprise one or more vortex units which are configured to enable circular flow of the cooling agent along with one or more partitions. The one or more vortex units can be configured to allow the cooling agent to change the circulating flow area based on a pre-defined length of the second connecting tube and the pre-defined temperature range.

In an aspect, the one or more vortex units can be configured to enable the flow of the cooling agent through a countercurrent based channel with the one or more partitions, which allows transfer of the charged cooling agent and the discharged cooling agent at respective area.

In an aspect, the one or more partitions can be configured to maintain the pre-defined temperature of the cooling agent. A count of one or more partitions depends on the pre-defined length of the second connecting tube.

In an aspect, the cooling agent comprises at least one of a liquid, a gas, a dielectric fluid, and a glycol compound.

In an aspect, the system comprises a coating material comprising a highly thermal conductive hybrid composite material covering a maximum surface of the one or more battery cells. The coating material can comprise at least one of a Carbon Nanotube (CNT) composite, a Boron Nitride Nanotube (BNNT) composite, and a Graphene-based composite with at least one of a low atmosphere pressure, a high atmosphere pressure, and a vacuum based on an application requirement, to maintain the temperature of at least one of the battery pack and a system associated in at least one of a water, an air, a space and a underwater, with a requirement of cooling.

In an aspect, the system comprises at least one pressure vent configured to release the pressure from inside of the battery pack due to one or more chemical reactions of the one or more battery cells during operation.

In an aspect, the charged cooling agent is configured to reduce the temperature of the one or more battery cells.

In an aspect, the system comprises one or more terminal signal pins configured to monitor one or more parameters of the one or more battery cell. The one or more parameters comprise at least one of a capacity of the battery cell, an energy density, a self-discharge rate, and an operating temperature of the battery cell.

In an aspect, one or more electrical external connections of the battery pack interconnected to at least one battery cell terminals, and the one or more battery cells.

In an aspect of the present disclosure discloses a method for facilitating cooling of a battery pack by using a portable counter-current flow thermal management system. The method comprises the step of enabling, by a pump, circulation of a cooling agent with a pre-defined rate of flow based on a real-time temperature data detected from the battery pack. The cooling agent comprises at least one of a liquid, a gas, a dielectric fluid, and a glycol compound. The method comprises the step of receiving, by heat exchanger unit, the cooling agent and automatically adjusting a pre-defined temperature of the cooling agent. The method comprises the step of providing, by a second connecting tube, a counter-current flow of the cooling agent to one or more battery cells in the battery pack. The second connecting tube comprising the step of receiving and conducting, by an input terminal, charging of the cooling agent to facilitate the thermal management by circulating the cooling agent with a pre-defined temperature range to the one or more battery cells. The second connecting tube comprising the step of conducting, by an output terminal, discharging of the cooling agent to facilitate the thermal management by circulating the cooling agent with the pre-defined temperature range from the one or more battery cells. The output terminal can be coupled to the input terminal along a horizontal axis in a bent fashion facilitating a single interface enabling the counter-current flow of the cooling agent across one or more battery cells in the battery pack.

In an aspect, the counter-current flow of the cooling agent is based on a fish gill-based technique for providing thermal management and facilitating cooling of the one or more battery cells in the battery pack.

In an aspect, the method comprises the step of enabling, by a portable counter-current flow thermal management system, flow of a charged cooling agent and a discharged cooling agent through the second connecting tube and the one or more battery cells in a parallel mode.

In an aspect, the method comprises the step of enabling, by a portable counter-current flow thermal management system, the counter-current flow of the cooling agent based on the fish gill based technique though a first end of the second connecting tube comprising at least one of the input terminal and the output terminal, and a second end of the second connecting tube being end cover.

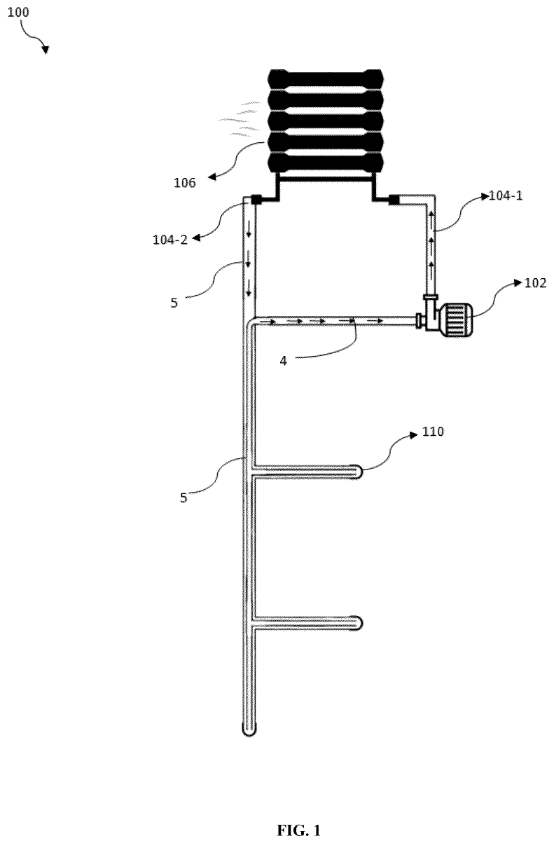

FIG. 1 illustrates an exemplary architecture of the proposed portable counter-current flow thermal management system, in accordance with an embodiment of the present disclosure.

In an embodiment, a portable counter-current flow thermal management system 100 facilitating cooling of a battery pack 1. The system 100 comprises at least one pump 102, a first connecting tube 104-1, and a second connecting tube 104-2 (also referred as a connecting tube 104, or a cooling tube 104, herein), a heat exchanger unit 106. The at least one pump 102 can be configured enable circulation of a cooling agent with a pre-defined rate of flow based on a real-time temperature data detected from the battery pack 1. The cooling agent may include, but not limited to a liquid, a gas, a dielectric fluid, a glycol compound, and the like. Further, the first connecting tube 104-1 can be operatively coupled to the at least one pump 102 and can be configured to facilitate flow of the cooling agent. The heat exchanger 106 unit can be operatively coupled to the first connecting tube 104-1, and configured to receive the cooling agent, and automatically adjust the temperature of the cooling agent. The second connecting tube 104-2 can be operatively coupled to the heat exchanger unit 106 and configured to receive and provide a counter-current flow of the cooling agent to one or more battery cells 10 in the battery pack 1.

In an embodiment, the second connecting tube 104-2 comprises an input terminal 5 and an output terminal 4. The input terminal 5 can be configured to receive and conduct charging of the cooling agent to facilitate the thermal management by circulating the cooling agent with a pre-defined temperature range to the one or more battery cells 10. The output terminal 4 can be configured to conduct discharging of the cooling agent to facilitate the thermal management by circulating the cooling agent with the pre-defined temperature range from the one or more battery cells 10.

In an embodiment, a coating material comprising a highly thermal conductive hybrid composite material covering a maximum surface of the one or more battery cells 10, Further, the coating material includes, but not limited to, a Carbon Nanotube (CNT) composite, a Boron Nitride Nanotube (BNNT) composite, a Graphene-based composite, and the like. The Graphene-based composite includes at least one of a low atmosphere pressure, a high atmosphere pressure, and a vacuum based on an application requirement, to maintain the temperature of at least one of the battery pack (10) and a system associated in at least one of a water, an air, a space and a underwater, with a requirement of cooling.

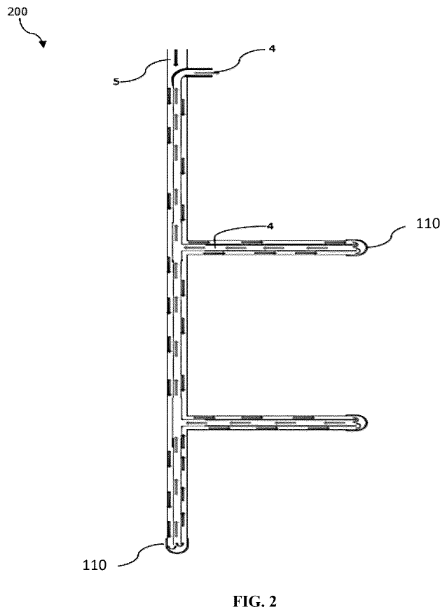

FIG. 2 illustrates an exemplary representation of a countercurrent flow of a cooling agent in the proposed system, in accordance with an embodiment of the present disclosure.

In an embodiment, the output terminal 5 is coupled to the input terminal 4 along a horizontal axis in a bent fashion facilitating a single interface enabling the counter-current flow of the cooling agent across one or more battery cells 10 in the battery pack 1. The counter-current flow of the cooling agent may be based on a fish gill-based technique for providing thermal management and facilitating cooling of the one or more battery cells 10 in the battery pack 1. Further, the fish gill-based technique may be configured to enable flow of a charged cooling agent and a discharged cooling agent through the second connecting tube 104-2 and the one or more battery cells 10 in a parallel mode. The charged cooling agent pertains to directing the flow of the cooling agent with a low temperature range from the input terminal 5 to the one or more battery cells 10. The discharged cooling agent pertains to directing flow of the cooling agent with a high temperature range from the one or more battery cells 10 to the output terminal 4 and the at least one pump 102.

In an embodiment, the counter-current flow of the cooling agent may be enabled based on the fish gill based technique though a first end of the second connecting tube 104-2 comprising at least one of the input terminal 5 and the output terminal 4, and a second end of the second connecting tube 104-2 being end cover 110.

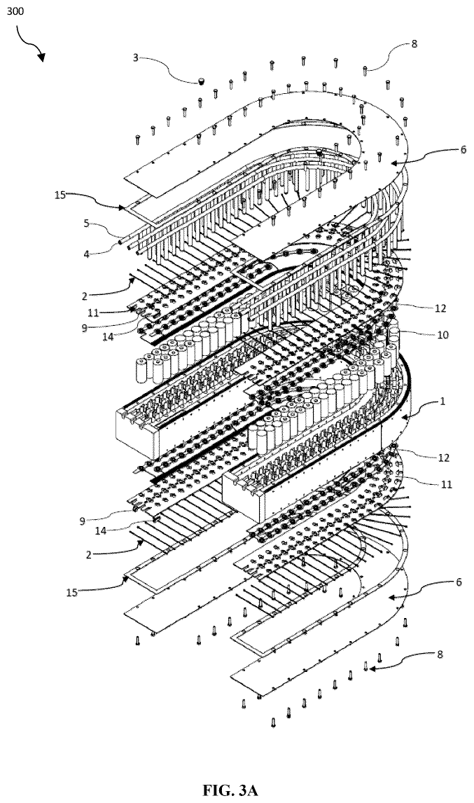

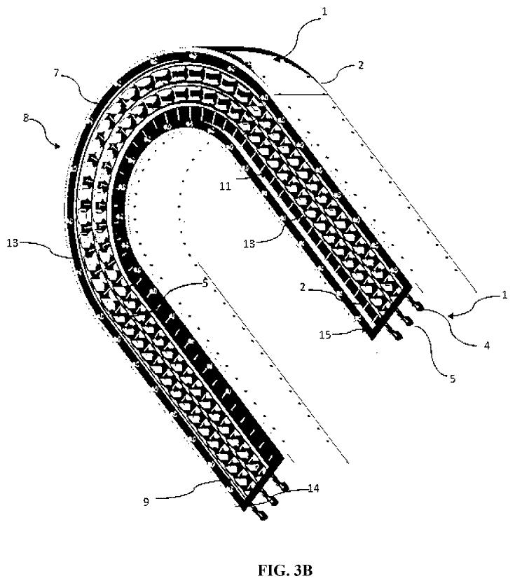

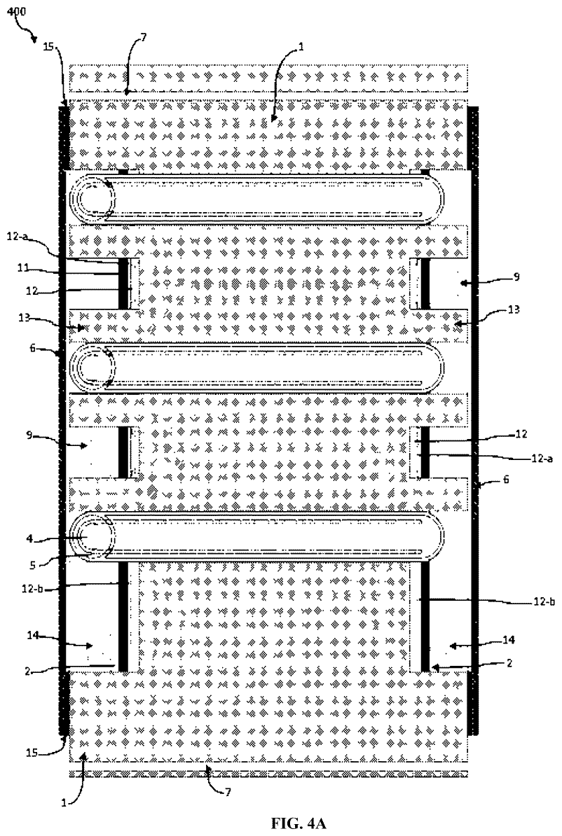

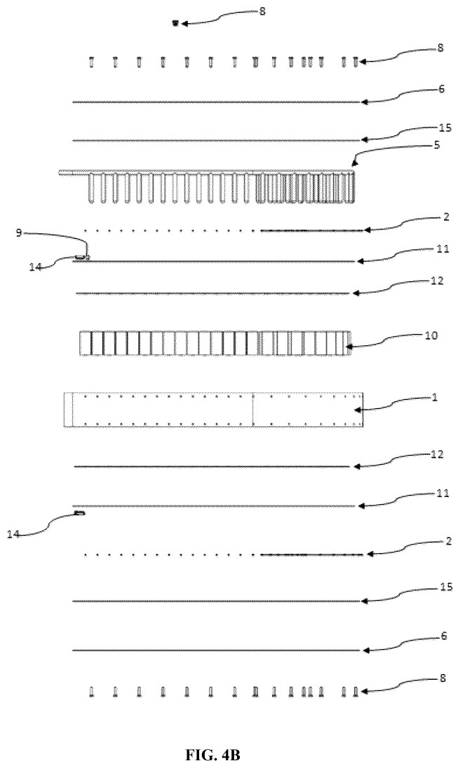

FIGS. 3A-3B illustrates an exemplary architecture of an exploded isometric view and a battery pack isometric view without top cover, respectively, in accordance with an embodiment of the present disclosure. FIGS. 4A-4B illustrates an exemplary architecture of a front view cross-section from cell with countercurrent flow liquid cooling tubes, and a battery pack exploded side view, respectively, in accordance with an embodiment of the present disclosure.

In an embodiment, the system 100 comprises a battery pack 1, one or more force-fitting pins 2, at least one pressure vent 3, an output terminal 4, the input terminal 5, one or more end cover plates 6, an edge of edge of the battery block 7, a connecting member 8, one or more electrical external connections 9, the one or more battery cells 10, an insulation sheet 11, a rounded embossed material 12, one or more extruded pillars 13, one or more terminal signal pins 14, and a thin sheet 15.

In an embodiment, the surface of the battery pack 1 includes one or more holes configured for enabling one or more force-fitting pins 2, which can apply force on the one or more battery cell interconnecting board, and the end of one or more force-fitting pins are locked with inserts. The at least one pressure vent 3 which may be releasing the gas and/or pressure from inside of the battery pack 1 due to one or more chemical reactions of the one or more battery cells 10 during operation. The output terminal may be configured to circulate the cooling agent with high temperature, which may be circulating from the input terminal 5. Further, a metallic and/or non-metallic end cover plates 6 may be used for covering the battery pack body and/or block. At the edge of the battery block 7 and/or body 1 one or more tiny holes are acting as a damping part to prevent the damage from the mechanical force. A connecting member 8 may be configured to hold the cover plate 6 the battery pack 1 together.

Further, the one or more electrical external connections of the battery pack 1 which may be interconnected with battery cell terminals/battery cell 10. The insulation sheet 11 may be configured to hold the battery cell metallic interconnection bars and insulating it electrically from the one or more force-fitting pins 2 and the cover 6. The rounded embossed material 12 may be configured to connect the individual battery cells 10 at both end terminals mechanically for electrical series and/or parallel interconnection. Further, the extra extruded pillars 13 may be configured to manage the stress of the structure member to protect battery 10 cells, electrical interconnecting 12 plates and/or bars and/or parts, liquid circulation 4 and/or 5 pipes from external forces. Further, the terminal signal pins 15 may be configured to monitor one or more parameters of the battery cell. The one or more parameters of the battery cell can include, but not limited to: a capacity of the battery cell, an energy density, a self-discharge rate, an operating temperature of the battery cell, and the like. The thin sheet 15 may contain elastic properties material acting as sealant or gasket for air tight-fitting.

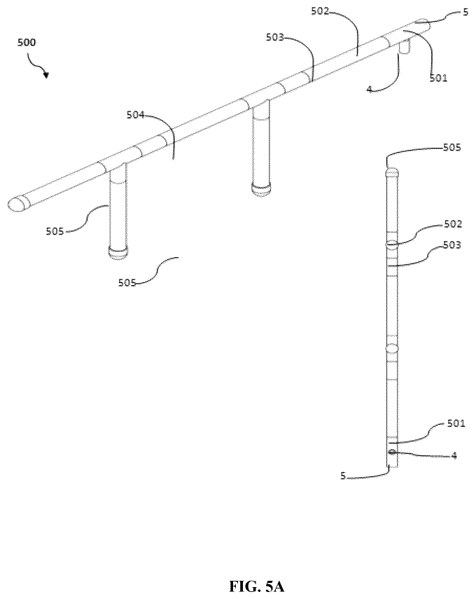

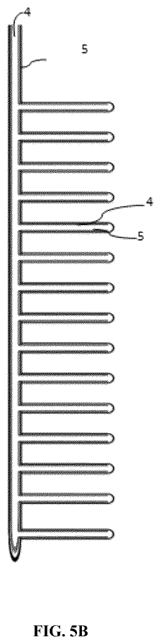

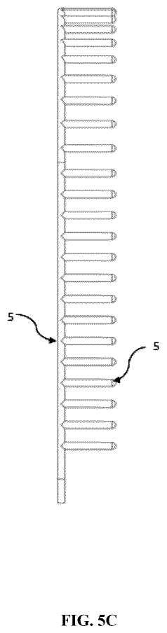

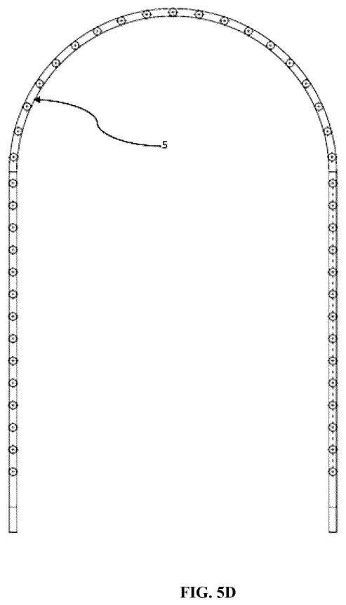

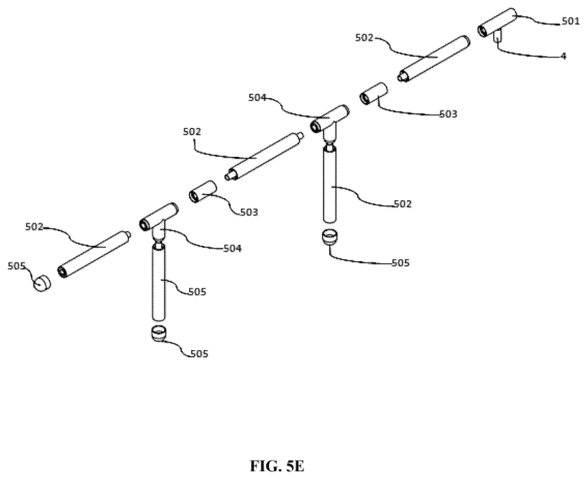

FIGS. 5A-5F illustrates an exemplary architecture representing different views of connecting tube with countercurrent flow of the cooling agent, in accordance with an embodiment of the present disclosure.

In an embodiment, the connecting tube 104 can include a liquid cooling channel coupler 502, a countercurrent based channel 502, one or more vortex units 503, a connecting tubes T-joiner 504, and an end cover. FIG. 5A depicts a Countercurrent flow liquid cooling top view &isometric view. FIG. 5B depicts a Countercurrent flow liquid cooling pipe side cross-section view. FIG. 5C depicts a Countercurrent flow liquid cooling pipe side view. FIG. 5D depicts a Countercurrent flow liquid cooling pipe top view. FIG. 5E depicts a Countercurrent flow liquid cooling channel exploded side view. FIG. 5F depicts a countercurrent flow liquid cooling channel exploded cross-section.

In an embodiment, the connecting tube 104 may include a channel coupler 501, a countercurrent based channel 502, one or more vortex 503, a T-joiner 504, and an end cover 505. The channel coupler 501 may be configured to connect the input terminal 5 and the output terminal 4, along with appropriate separation area. The countercurrent based channel 502 may comprise one or more partitions which may be configured to allow transfer of the cooling agent at respective terminals. The one or more vortex 503 along with one or more partitions can be configured to allow to change the circulating flow 403 area as per a pre-defined length and a pre-defined temperature of the connecting tube 104.

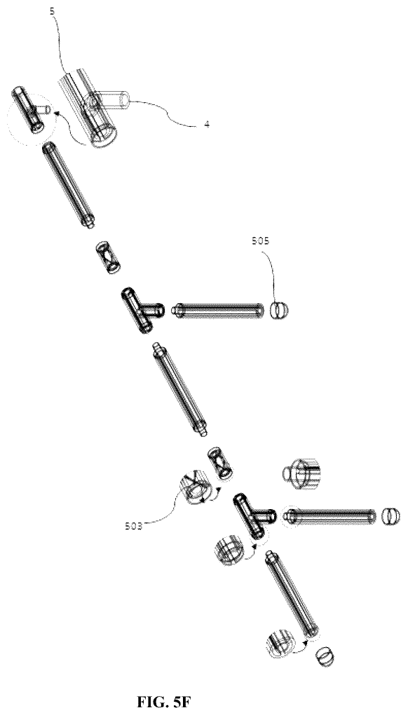

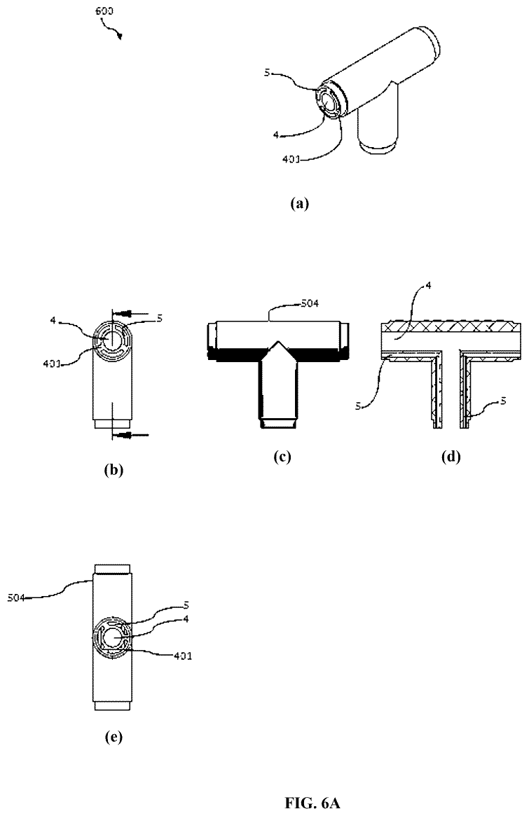

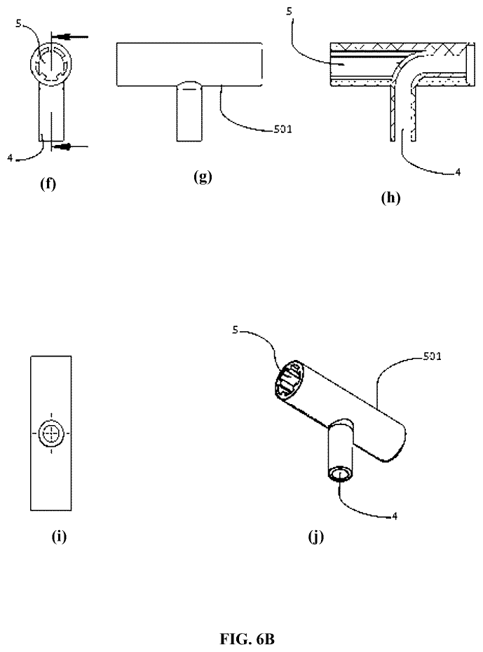

FIGS. 6A-6C illustrates an exemplary architecture representing different views of cooling channels with countercurrent flow of the cooling agent in the connecting tubes, in accordance with an embodiment of the present disclosure.

In an embodiment, FIG. 6A (a)-(e) depicts the T-jointer 504 with partition side view, front view, bottom view, isometric & cross-section view, respectively. The T-jointer 504 may be configured to connect the input terminal 5 and the output terminal 4 of the battery pack 1. The connection is vital for enabling the flow of the cooling agent between the one or more battery cells 10. The T-jointer 504 ensures a secure and reliable electrical connection, which is essential for the efficient operation of the battery pack 1. The T-jointer plays a critical role in the functionality and performance of battery packs 1, ensuring that they can deliver the required power output to meet the needs of various applications.

In an embodiment, FIG. 6B (f)-(j) depicts the channel coupler with partition side view, front view, bottom view, isometric view, cross-section view, respectively. FIG. 6C (k)-(n) depicts a structure of vortex with partition side view, front view, bottom view, isometric view, and across-section view, respectively. The second connecting tube 104-2 may comprise one or more vortex units 503 which are configured to enable circular flow of the cooling agent along with one or more partitions 401. The one or more vortex units 503 may be configured to allow the cooling agent to change the circulating flow 403 area based on a pre-defined length of the second connecting tube 106-2 and the pre-defined temperature range.

In an embodiment, the one or more vortex units 503 may be configured to enable the flow of the cooling agent through a countercurrent based channel 502 with the one or more partitions 401 which allows transfer of the charged cooling agent and the discharged cooling agent at respective area. The one or more partitions 401 are configured to maintain the pre-defined temperature of the cooling agent, where a count of one or more partitions 401 depends on the pre-defined length of the second connecting tube 104-2.

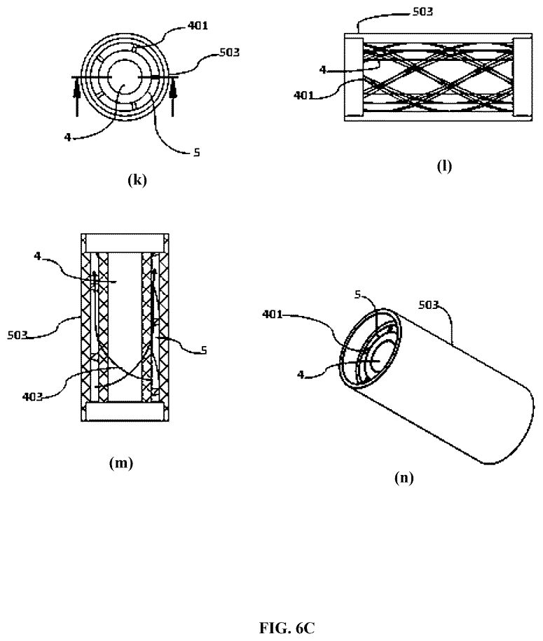

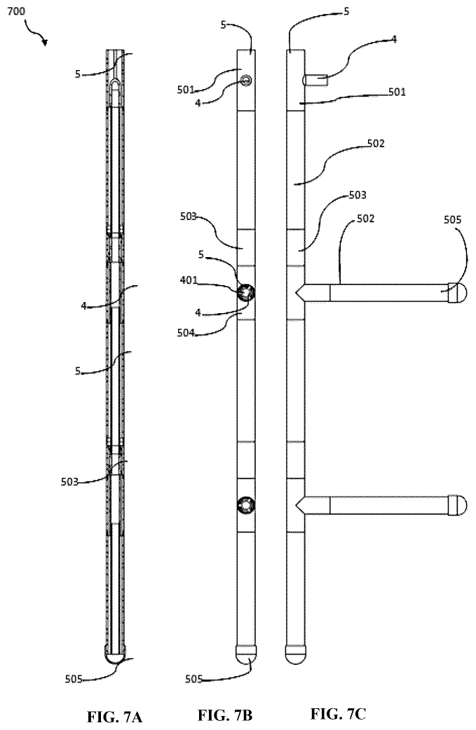

FIG. 7A-7C illustrates an exemplary representation of a countercurrent flow of a cooling agent in the connecting tube with side view, a bottom view, and cross-section view, in accordance with an embodiment of the present disclosure.

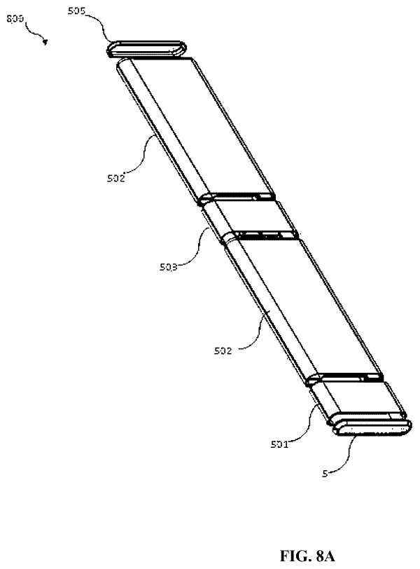

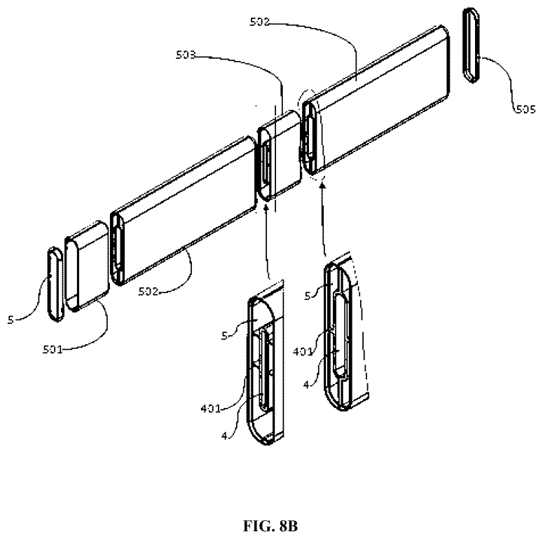

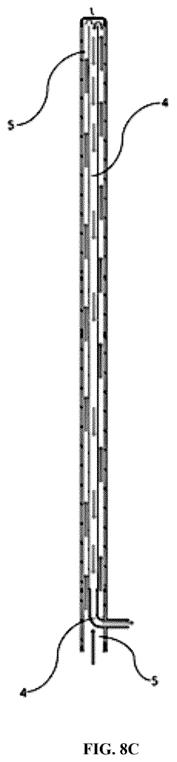

FIGS. 8A-8C illustrates an exemplary architecture of a portable counter-current flow thermal management system in rectangular form, in accordance with an embodiment of the present disclosure.

In an embodiment, FIG. 8A depicts a rectangular shape countercurrent flow liquid cooling channel exploded side view. FIG. 8B depicts a rectangular shape countercurrent flow liquid cooling channel enlarge of vortex/coupler with partition exploded view. FIG. 8C depicts a schematic diagram of countercurrent flow of liquid/air in rectangular shape tube.

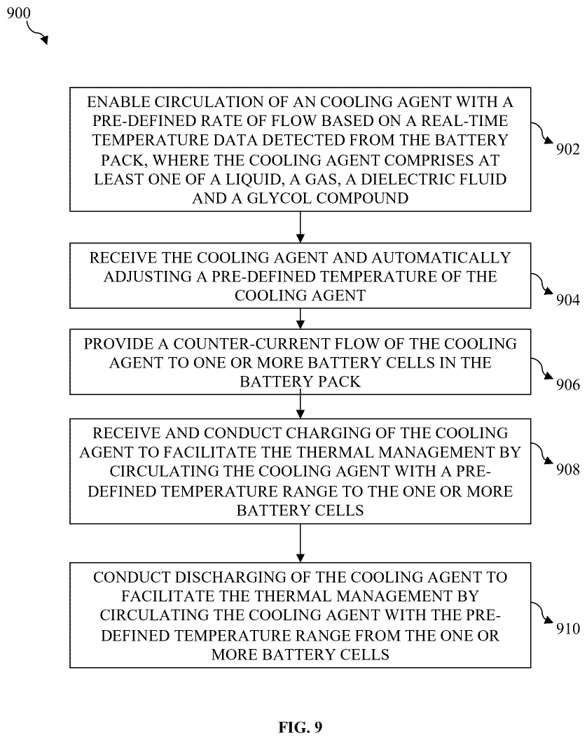

FIG. 9 illustrates an exemplary flow diagram depicting a method 900 for facilitating cooling of a battery pack by using a portable counter-current flow thermal management system, in accordance with an embodiment of the present disclosure.

In an embodiment, the method 900 for facilitating cooling of a battery pack by using a portable counter-current flow thermal management system 100. At step 902, enabling, by a pump 102, circulation of a cooling agent with a pre-defined rate of flow based on a real-time temperature data detected from the battery pack 10. The cooling agent comprises at least one of a liquid, a gas, a dielectric fluid, and a glycol compound. At step 904, receiving, by heat exchanger unit 106, the cooling agent and automatically adjusting a pre-defined temperature of the cooling agent. At step 906, providing, by a second connecting tube 104-2, a counter-current flow of the cooling agent to one or more battery cells 10 in the battery pack 1. At step 908, receiving and conducting, by an input terminal 5 of the second connecting tube 104-2, charging of the cooling agent to facilitate the thermal management by circulating the cooling agent with a pre-defined temperature range to the one or more battery cells. At step 910, conducting, by an output terminal 4 of the second connecting tube 104-2, discharging of the cooling agent to facilitate the thermal management by circulating the cooling agent with the pre-defined temperature range from the one or more battery cells 10. The output terminal 4 can be coupled to the input terminal 5 along a horizontal axis in a bent fashion facilitating a single interface enabling the counter-current flow of the cooling agent across one or more battery cells 10 in the battery pack 1.

If the specification states a component or feature “may”, “can”, “could”, or “might” be included or have a characteristic, that particular component or feature is not required to be included or have the characteristic.

As used in the description herein and throughout the claims that follow, the meaning of “a”, “an”, and “the” includes plural reference unless the context clearly dictates otherwise. Also, as used in the description herein, the meaning of “in” includes “in” and “on” unless the context clearly dictates otherwise.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are comprised to enable a person having ordinary skill in the art to make and use the invention when combined with information and knowledge available to the person having ordinary skill in the art.

### Advantages of the Invention

The present disclosure implements a portable counter-current flow thermal management system facilitating cooling of a battery pack, and method thereof.

The present disclosure provides a simple, a reusable, a reliable and a portable counter-current flow thermal management system to maintain temperature of a battery pack.

The present disclosure eliminates presence of air gap in the battery pack. The maximum surface of the battery cell is surrounded by a highly thermal conductive hybrid composite material.

The present disclosure enables implementation of a simple and effective countercurrent flow of a coolant agent which can be circulating to/from the battery cells in a parallel mode based on a temperature difference of the battery cells.

The present disclosure provides a flexible, a reusable, an efficient battery cell to battery pack by reducing the complexity, manpower, import dependency, generation of debris, with high manufacturing portability without compromising the external weather applications.

The present disclosure provides a scalable, a cost-effective and easy on-site maintenance portable counter-current flow thermal management system.

We claim:

1. A portable counter-current flow thermal management system facilitating cooling of a battery pack, the portable counter-current flow thermal management system comprising:
at least one pump configured enable circulation of a cooling agent with a pre-defined rate of flow based on a real-time temperature data detected from the battery pack;
a first connecting tube operatively coupled to the at least one pump, and configured to facilitate flow of the cooling agent;
a heat exchanger unit operatively coupled to the first connecting tube, and configured to receive the cooling agent, and automatically adjust the temperature of the cooling agent; and
a second connecting tube operatively coupled to the heat exchanger unit, and configured to receive and provide a counter-current flow of the cooling agent to one or more battery cells in the battery pack, wherein the second connecting tube comprises:
an input terminal configured to receive and conduct charging of the cooling agent to facilitate the thermal management by circulating the cooling agent with a pre-defined temperature range to the one or more battery cells; and
an output terminal and configured to conduct discharging of the cooling agent to facilitate the thermal management by circulating the cooling agent with the pre-defined temperature range from the one or more battery cells.

2. The portable counter-current flow thermal management system of claim 1, wherein the output terminal is coupled to the input terminal along a horizontal axis in a bent fashion facilitating a single interface enabling the counter-current flow of the cooling agent across one or more battery cells in the battery pack.

3. The portable counter-current flow thermal management system of claim 2, wherein the counter-current flow of the cooling agent is based on a fish gill-based technique for providing thermal management and facilitating cooling of the one or more battery cells in the battery pack.

4. The portable counter-current flow thermal management system of claim 3, wherein the fish gill-based technique is configured to enable flow of a charged cooling agent and a discharged cooling agent through the second connecting tube and the one or more battery cells in a parallel mode.

5. The portable counter-current flow thermal management system of claim 3, wherein the portable counter-current flow thermal management system is configured to:
enable the counter-current flow of the cooling agent based on the fish gill based technique though a first end of the second connecting tube comprising at least one of the input terminal and the output terminal, and a second end of the second connecting tube being end cover.

6. The portable counter-current flow thermal management system of claim 3, wherein the charged cooling agent pertains to directing the flow of the cooling agent with a low temperature range from the input terminal to the one or more battery cells,
wherein the discharged cooling agent pertains to directing flow of the cooling agent with a high temperature range from the one or more battery cells to the output terminal and the at least one pump.

7. The portable counter-current flow thermal management system of claim 1, wherein the second connecting tube comprises one or more vortex units which are configured to enable circular flow of the cooling agent along with one or more partitions,
wherein the one or more vortex units are configured to allow the cooling agent to change the circulating flow area based on a pre-defined length of the second connecting tube and the pre-defined temperature range.

8. The portable counter-current flow thermal management system of claim 6, wherein the one or more vortex units are configured to enable the flow of the cooling agent through a countercurrent based channel with the one or more partitions which allows transfer of the charged cooling agent and the discharged cooling agent at respective area.

9. The portable counter-current flow thermal management system of claim 8, wherein the one or more partitions is configured to maintain the pre-defined temperature of the cooling agent, wherein a count of one or more partitions depends on the pre-defined length of the second connecting tube.

10. The portable counter-current flow thermal management system of claim 1, wherein the cooling agent comprises at least one of a liquid, a gas, a dielectric fluid, and a glycol compound.

11. The portable counter-current flow thermal management system of claim 1, wherein the portable counter-current flow thermal management system comprises:
a coating material comprising a highly thermal conductive hybrid composite material covering a maximum surface of the one or more battery cells, wherein the coating material comprises at least one of a Carbon Nanotube (CNT) composite, a Boron Nitride Nanotube (BNNT) composite, and a Graphene-based composite with at least one of a low atmosphere pressure, a high atmosphere pressure, and a vacuum based on an application requirement, to maintain the temperature of at least one of the battery pack and a system associated in at least one of a water, an air, a space and a underwater, with a requirement of cooling.

12. The portable counter-current flow thermal management system of claim 1, wherein the portable counter-current flow thermal management system comprises:
at least one pressure vent configured to release the pressure from inside of the battery pack due to one or more chemical reactions of the one or more battery cells during operation.

13. The portable counter-current flow thermal management system of claim 1, wherein the charged cooling agent is configured to reduce the temperature of the one or more battery cells.

14. The portable counter-current flow thermal management system of claim 1, wherein the portable counter-current flow thermal management system comprises:
one or more terminal signal pins configured to monitor one or more parameters of the one or more battery cell, wherein the one or more parameters comprises at least one of a capacity of the battery cell, an energy density, a self-discharge rate, and an operating temperature of the battery cell.

15. The portable counter-current flow thermal management system of claim 1, wherein one or more electrical external connections of the battery pack interconnected to at least one battery cell terminals, and the one or more battery cells.

16. A method for facilitating cooling of a battery pack by using a portable counter-current flow thermal management system, the method comprises the steps of:
enabling, by a pump, circulation of a cooling agent with a pre-defined rate of flow based on a real-time temperature data detected from the battery pack, wherein the cooling agent comprises at least one of a liquid, a gas, a dielectric fluid, and a glycol compound;
receiving, by a heat exchanger unit, the cooling agent and automatically adjusting a pre-defined temperature of the cooling agent; and
providing, by a second connecting tube, a counter-current flow of the cooling agent to one or more battery cells in the battery pack, wherein the second connecting tube comprising the steps of:
receiving and conducting, by an input terminal, charging of the cooling agent to facilitate the thermal management by circulating the cooling agent with a pre-defined temperature range to the one or more battery cells); and
conducting, by an output terminal discharging of the cooling agent to facilitate the thermal management by circulating the cooling agent with the pre-defined temperature range from the one or more battery cells,
wherein the output terminal is coupled to the input terminal along a horizontal axis in a bent fashion facilitating a single interface enabling the counter-current flow of the cooling agent across one or more battery cells in the battery pack.

17. The method of claim 16, wherein the counter-current flow of the cooling agent is based on a fish gill-based technique for providing thermal management and facilitating cooling of the one or more battery cells in the battery pack.

18. The method of claim 16, wherein the method comprising the steps of:
enabling, by a portable counter-current flow thermal management system, flow of a charged cooling agent and a discharged cooling agent through the second connecting tube and the one or more battery cells in a parallel mode.

19. The method of claim 17, wherein the method comprising the steps of:
enabling, by a portable counter-current flow thermal management system, the counter-current flow of the cooling agent based on the fish gill based technique though a first end of the second connecting tube comprising at least one of the input terminal and the output terminal, and a second end of the second connecting tube being end cover.
